(19) United States
(12) Patent Application Publication
(10) Pub. No.: US 2006/0018107 A1
(43) Pub. Date: Jan. 26, 2006

(54) Emergency light element having a digital addressable control interface

(75) Inventor: Andreas Huber, Traunreut (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 11/178,369

(22) Filed: Jul. 12, 2005

(30) Foreign Application Priority Data
Jul. 22, 2004 (DE) 10 2004 035 678.5

(51) Int. Cl. F21V 19/04; G08B 21/00

(52) U.S. Cl. 362/20; 340/641

(57) ABSTRACT

The invention relates to an emergency light element which has a control output for the purpose of controlling a normal-operation EB.

### TECHNICAL FIELD

The present invention relates to an emergency light element having a digital addressable control interface.

For many lighting tasks, so-called emergency light elements are provided in addition to electronic ballasts for normal operation, for example ballasts which can operate low-pressure discharge lamps using a domestic power supply voltage. These emergency light elements are envisaged, for safety reasons, for the case of a failure of the power supply and therefore have a battery or a battery connection and a device for detecting the emergency lighting situation, i.e. the power supply failure. The battery is generally integrated. Independently thereof, a ballast for operating a lamp using the battery is in each case provided and is set in operation in an emergency lighting situation. This then operates a lamp which is provided specifically for this purpose or else is already used in the case of normal operation and thus provides emergency lighting.

### BACKGROUND ART

Such emergency light elements are known per se, in particular also as complete luminaires having the lamp to be operated in an emergency lighting situation.

It is also known that such emergency light elements are used within larger lighting systems in which it is often necessary to provide lighting to a particular extent even in the case of a power supply failure, for example in order to ensure evacuation or to prevent a panic situation or accidents.

Finally, lighting systems have recently been disclosed which are controlled via digital control signals, in the case of which the ballasts used thus have digital addressable interfaces for the purpose of receiving control signals.

### DISCLOSURE OF THE INVENTION

The present invention is therefore based on the technical problem of specifying an advantageous emergency light element which is well suited to use in a digitally controlled lighting system.

The invention is concerned with an emergency light element having a battery connection, a device for the purpose of detecting a failure in the power supply system, and an electronic ballast which is designed for battery operation of a lamp, characterized in that the emergency light element has a digital addressable control interface, and a control output for an electronic ballast for normal operation, and is designed to allow the electronic ballast for normal operation to be controlled during normal operation via the digital addressable control interface.

The invention therefore provides for an emergency light element, on the one hand, to be equipped with a digital addressable control interface, but, on the other hand, also for a control output for an electronic ballast for normal operation (referred to below for short as normal-operation EB) to be provided. Driving of a normal-operation EB via the emergency light element according to the invention is thus envisaged. A separate digital addressable control interface for the normal-operation EB is thus no longer necessary, with the result that a certain amount of technical complexity, but in particular one digital address, is eliminated.

In addition, flexible solutions can be found, as is illustrated further below by the exemplary embodiment, which also offer, in particular, favorable possibilities for function tests.

In one advantageous embodiment, the emergency light element has on the one hand a connection for a lamp to be operated in an emergency lighting situation which can be connected to the EB, which is designed for battery operation, within the emergency light element. In addition, the emergency light element in this case also has, however, a connection for the normal-operation EB, via which connection said normal-operation EB can operate this lamp during normal operation. In an emergency lighting situation, the system is thus switched over from lamp operation using the normal-operation EB to the “emergency-light EB” within the emergency light element.

The lamp is advantageously integrated, i.e. it is as a whole an emergency luminaire. The normal-operation EB is likewise advantageously integrated. It is therefore either a combined normal-operation/emergency luminaire or, if no lamp is integrated, a combined normal-operation/emergency-light EB. However, the invention naturally also relates to embodiments in which the lamp and/or the normal-operation EB are provided externally and can merely be connected to the emergency light element.

A specific embodiment of the invention provides a controllable supply output for the normal-operation EB. The term control output in this case thus includes not only exclusively control signal outputs but also outputs which have, inter alia control functions, i.e. which output control operations for the emergency light element. In particular, it may be a supply output, for example a phase output, which may be disconnected in a controlled manner within the emergency light element even when the power supply is still present. This is intended to apply to the case in which the emergency light element, as preferred, has an input for an externally connected power supply (in particular phase). The disconnection of this supply output for the normal-operation EB takes place in response to control signals entering via the digital addressable interface.

In this embodiment, the emergency light element can be used within (at least partially) digitally controlled lighting systems together with a conventional normal-operation EB which is not a digital addressable ballast itself. This normal-operation EB can then be connected and disconnected, for example, via the abovementioned externally connected phase which is, however, connected via the emergency light element. In this case, the emergency light element can disconnect this power supply to the normal-operation EB in response to digital control signals. It is thus possible, for example, for function tests of the emergency light functions to take place which run via the digital controller, and in the case of which the normal-operation EB(s) then need(s) to be disconnected although the actual power supply is still present.

In another advantageous refinement, which may be provided, however, completely in addition to that already described, the control output is a separate digital output. In particular those digital control signals entering the digital addressable interface can preferably be passed on as such to the normal operation EB, which in this case likewise has a digital addressable interface of an identical or a compatible type. In principle, however, it is also conceivable for the emergency light element to produce other types of digital control signals and to output them to the normal-operation EB. In the preferred case in which the digital control signals are passed on, however, these signals are preferably tested internally for relevance to the emergency light element itself. In addition, the emergency light element can periodically interrogate specific operating and configuration parameters of the normal-operation EB and store them in an internal memory in order to be able to answer enquiries as to the state of the normal-operation EB without or with little time delay.

The emergency light element according to the invention may also be combined with a plurality of normal-operation EBs, whether they be integrated or external. They may also be driven by means of one and the same control output, i.e. in the case of the separate digital control output in the form of a bus line, and in the case of the control output which connects the power supply line in the form of a parallel circuit.

In addition to the abovementioned possibilities for function tests using the central digital controller for the lighting system, the emergency light element preferably has further connections for a function test device which is connected locally in order to test the individual emergency light element. Where required, a local test and display option can thus be implemented.

The invention relates to electronic ballasts in very general terms, i.e. to any form of operating devices for lamps. The preferred case and that which is most relevant in practice is, however, EBs for low-pressure discharge lamps, for example in tubular form or as so-called energy-saving lamps.

### BRIEF DESCRIPTION OF THE DRAWINGS

An exemplary embodiment will be explained in more detail below in which the individual features can also be considered to be critical to the invention in other combinations. In addition, as a precaution reference is made to the fact that the description above and below can also be understood implicitly as a disclosure of a method for producing the emergency light element and a method for operating the emergency light element, corresponding luminaires and the lighting system.

FIG. 1 shows an emergency light element according to the invention having a lamp connected.

FIG. 2 shows the emergency light element shown in FIG. 1 having a normal-operation EB additionally connected and a further lamp.

FIG. 3 shows the emergency light element shown in FIGS. 1 and 2 having two digital addressable normal-operation EBs and in total three lamps.

FIG. 4 shows the internal design of the emergency light element shown in FIGS. 1-3.

### BEST MODE FOR CARRYING OUT THE INVENTION

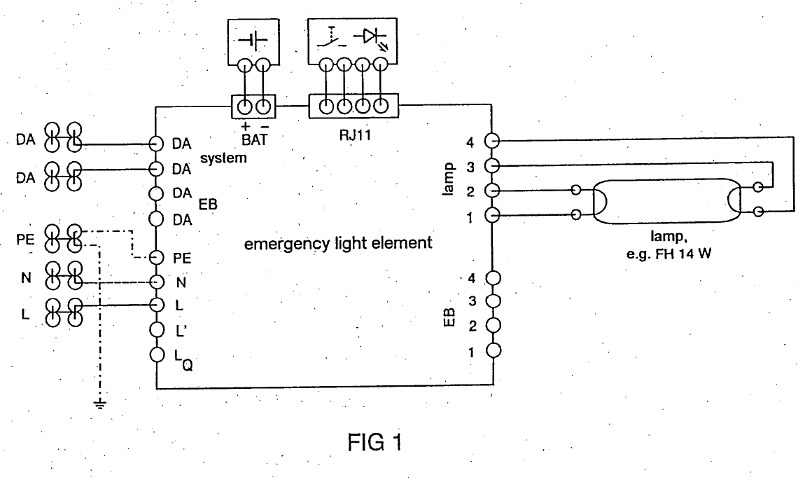

FIG. 1 shows an emergency light element according to the invention in a particularly simple application. In this exemplary embodiment, the emergency light element is part of an emergency luminaire and operates the tubular low-pressure discharge lamp of the FH 14 W type shown on the right-hand side. In addition, it contains an emergency-light EB (not illustrated in any more detail in FIG. 1) and a battery, which is connected at the top on the left-hand side, for the purpose of supplying power to said emergency-light EB. The emergency lamp is operated via lamp connections having the references lamp 1 to 4 and, in the application illustrated here, is only used as an emergency lamp.

Shown in the left-hand, upper region are connections which are given the reference DA and which are differentiated by DA system and DA EB. External lines, namely control signal lines of a digital central control system, are connected to the connections DA system. In this case, this refers to the controller of a larger lighting system which controls the connected devices in accordance with the so-called DALI standard (digital addressable lighting interface) via respective digital addressable interfaces. The significance of the connections DA EB is yet to be explained below.

In addition, the emergency light element contains power supply lines, namely a phase L, a neutral conductor N and a ground PE, which are connected to connections having the same names. The significance of the unoccupied connections L′ and L_{Q} Will be explained further.

In addition, a connection given the reference RJ11 is provided at the top in the center and serves the purpose of connecting an external test device for local function tests of the emergency light element. The test device is illustrated with a switch symbol and a light-emitting diode symbol.

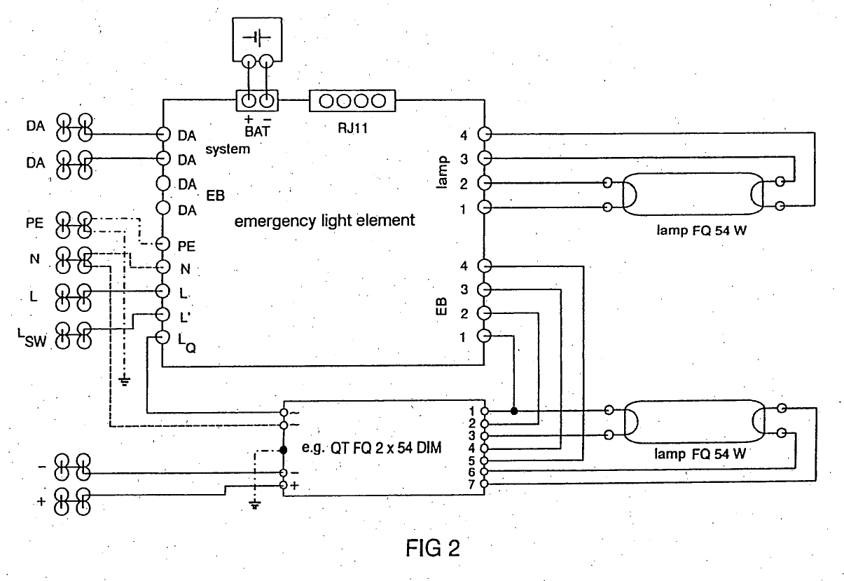

Used in this application is, therefore, an emergency luminaire which sets the illustrated lamp into operation via the battery BAT only in the case of a system voltage failure which is detected at the input L. This emergency luminaire can in this case be configured and monitored digitally. The control possibility, which is actually characteristic of the invention, for a normal-operation EB is provided here (connections L_{Q} and EB 1-4) but is not used in this example. A possible use with an external EB would correspond to FIG. 2.

In the application case shown in FIG. 2, the emergency light element is also connected to a dimmable normal-operation EB for two 54 W lamps, in this case of the type QT FQ 2×54 DIM, via the connections EB 1-4.

This normal-operation EB can operate the abovementioned emergency lamp during normal operation via the connections EB 1-4. In addition, the normal-operation EB can operate a further lamp of the same type which is illustrated next to it on the right-hand side and which, however, is not operated in an emergency lighting situation. The luminaire is thus a two-lamp luminaire having an emergency light function.

This conventional EB is supplied with power, on the one hand, directly via the neutral conductor N from the system power supply and, on the other hand, via the phase output L_{Q} of the emergency light element. The phase output L_{Q} can be connected to the phase input L′ of the emergency light element which is supplied with power via the line L_{SW}. In this case, it is an externally connected phase which can thus be disconnected, in contrast to the continuous power supply phase L, in order to control the mentioned normal-operation EB. In addition, the internal connection between the connections L′ and L_{Q} in the emergency light element can be connected such that a digital control signal (for example via the connections DA system) can open the connection between L′ and L_{Q}. In the case of a system test carried out via the digital controller, the normal-operation EB can thus be disconnected although no emergency lighting situation is present, i.e. the continuous phase L is active, and, in addition, the externally connected phase L_{SW} has not even been disconnected externally. It is thus possible for the digital controller in the emergency light element to simulate an emergency lighting situation without the normal-operation EB needing to convert the digital control signals themselves.

In the lower, left-hand region, a further, analogous connection of the normal-operation EB is also illustrated, it being possible for this connection to be, for example,a dimmer control connection.

This example thus shows, in particular, a two-lamp emergency luminaire in a lighting system having a mixed digital/analog controller. The control output for the purpose of controlling the normal-operation EB is the connected phase output L_{Q} which can be disconnected from the emergency light element independently of the phase input L or L′ if corresponding control signals are received via the digital addressable interface DA system.

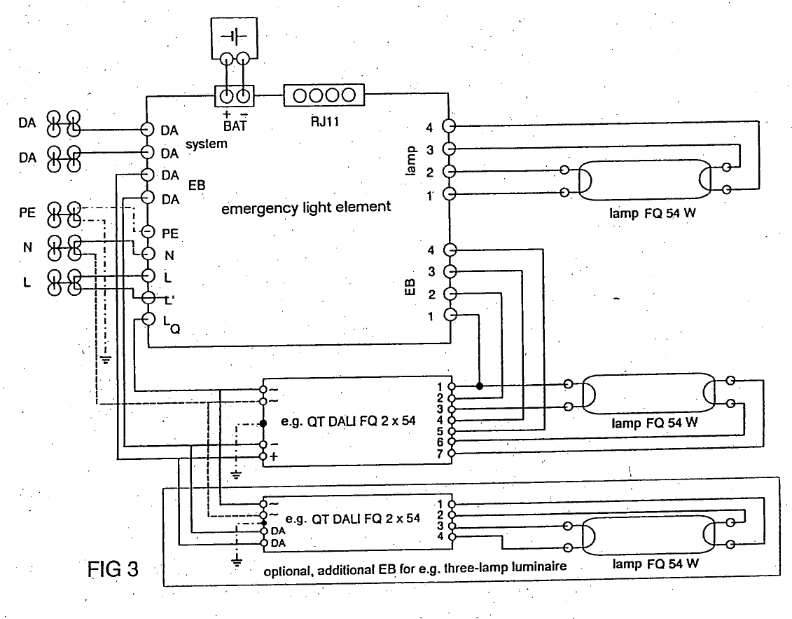

A further example in FIG. 3 shows the emergency light element from the previous figures together with a further, additional normal-operation EB. This emergency light element may thus be, overall, a three-lamp luminaire having an emergency light function, or the third EB could be connected as an external EB to a two-lamp luminaire having an emergency light function.

In addition, in this case the two normal-operation EBs, to be precise in this case of the type QT DALI FQ 2×54 or QT DALI FQ 1×54, are digital addressable ballasts. In this case, the luminaire including the possibly external third EB can thus be controlled and monitored digitally. In this case, all of the DALI commands are passed on from the emergency light element to the DALI EB. The commands received by the digital control device of the system in this case need to be interpreted by the emergency light element and sometimes even carried out. In order to be able to respond correctly to status interrogations from the control device, on the one hand, and queries from the DALI EB, on the other hand, the emergency light element also needs to store the received control commands and to periodically determine and store the state of the downstream EB itself. In addition, the emergency light-specific DALI commands naturally need to be processed, and the battery state and the system voltage need to be monitored constantly. The emergency light element thus in this case has the function of a DALI-controlled emergency light element having an integrated control device for further DALI EBs.

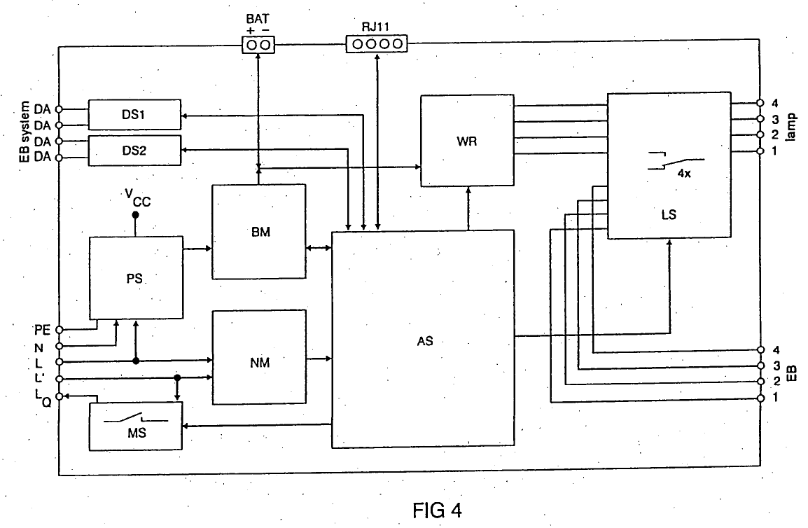

FIG. 4 shows the internal design of the emergency light element shown in FIGS. 1-3. The connections are labelled as in the abovementioned figures. The individual function blocks have essentially the following function.

The digital addressable interface is given the designation DS1. A further digital interface DS2 serves the purpose of communicating with the DALI EB.

The block PS produces the internal supply voltages from the abovementioned power supply.

The block BM contains the charging and monitoring electronics for the battery management and is therefore firstly connected to the block PS and secondly to the battery connection BAT.

The abbreviation NM represents the power supply system monitor. The latter monitors the system voltage applied and thus detects the presence of an emergency light situation. The power supply system monitor also detects the state of the connected system input L′. The monitored functions are passed on to the digital sequence controller AS which will be described below.

The block MS connects the supply voltage of the EB connected to the connection L_{Q} in FIG. 2, i.e. forms the switch between the connections L′ and L_{Q} and is driven by the sequence controller AS.

WR represents an inverter, namely an EB which has been optimized for battery operation for operating the connected low-pressure discharge lamp (for example FQ 54 W) in an emergency lighting situation, possibly at a reduced power. The inverter is therefore connected to battery connection BAT and is controlled, on the other hand, by the sequence controller AS.

LS denotes a multipole changeover switch which, during emergency light operation, decouples the lamp which is connected at the top right from the normal-operation EB, which is connected to the connections EB 1-4, and connects it to the inverter WR.

Finally, AS denotes the central digital sequence controller which contains, inter alia, the software elements required for digital DALI communication, necessary clock generators and decision logic for changing between normal and emergency light operation.

Overall, the emergency light element shown in FIG. 4 may be used in the manner illustrated in FIGS. 1-3 for the purpose of controlling the normal-operation EB and in the process occupies in each case only one digital address. In the process, in all cases it allows for test sequences which are triggered and monitored by the central digital controller, including the generation of result protocols which is prescribed in many cases. In addition, the tests can also be carried out “manually” at the individual luminaires via the further connection RJ11, and their result can be displayed locally. The normal-operation EB may be designed to be external or else integrated. The same applies to the low-pressure discharge lamps.

1. An emergency light element having
a battery connection,
a device for the purpose of detecting a failure in the power-supply system, and
an electronic ballast which is designed for battery operation of a lamp,
wherein the emergency light element has a digital addressable control interface,
and a control output for an electronic ballast for normal operation,
and is designed to allow the electronic ballast for normal operation to be controlled during normal operation via the digital addressable control interface.

2. The emergency light element as claimed in claim 1 having a lamp connection, by means of which the lamp to be operated in an emergency lighting situation can be operated during normal operation by means of the electronic ballast for normal operation, and having a normal-operation EB connection, by means of which a supply output of the electronic ballast for normal operation can be connected to the emergency light element.

3. The emergency light element as claimed in claim 1, in which the control output is an output for the purpose of supplying power to the electronic ballast for normal operation, which can be disconnected in response to control signals entering via the digital addressable control interface.

4. The emergency light element as claimed in claim 3, having an input connection for a continuous supply line and a further input connection for an externally connected supply line, which further supply input can be connected to the control output.

5. The emergency light element as claimed in claim 1, in which the control output for the electronic ballast for normal operation is digital, and passes on control signals entering via the digital addressable control interface to the electronic ballast for normal operation.

6. The emergency light element as claimed in claim 1 having an additional connection for a function test device for the purpose of carrying out a local function test.

7. The emergency light element as claimed in claim 1, in which the electronic ballasts are designed for low-pressure discharge lamps.

8. An emergency luminaire having an emergency light element as claimed in claim 1 and the emergency light lamp.

9. The emergency luminaire as claimed in claim 8, in which the electronic ballast for normal operation is integrated.

10. The emergency luminaire as claimed in claim 8 having two or more lamps.

11. The emergency light element as claimed in claim 2, in which the control output is an output for the purpose of supplying power to the electronic ballast for normal operation, which can be disconnected in response to control signals entering via the digital addressable control interface.

12. The emergency luminaire as claimed in claim 9 having two or more lamps.
